(19) United States
(12) Patent Application Publication
(10) Pub. No.: US 2007/0092236 A1
(43) Pub. Date: Apr. 26, 2007

(54) Image blur correcting device

(75) Inventor: Kazuhiko Onda, Saitama-shi (JP)

Correspondence Address: BIRCH STEWART KOLASCH & BIRCH, PO BOX 747, FALLS CHURCH, VA, 22040-0747, US

(73) Assignee: Fujinon Corporation

(21) Appl. No.: 11/584,602

(22) Filed: Oct. 23, 2006

(30) Foreign Application Priority Data
Oct. 24, 2005 (JP) 2005-308899

(51) Int. Cl. G03B 17/00

(52) U.S. Cl. 396/55

(57) ABSTRACT

The present invention provides an image blur correcting device, comprising: a correcting optical system which corrects a blur of an image formed by an imaging optical system; a holding frame which holds the correcting optical system and is supported movably within a plane orthogonal to an optical axis of the imaging optical system; a first and a second sliders which are orthogonal to the optical axis, are supported respectively slidably in a first and a second directions which are different, and are engaged with the holding frame; and a first and a second actuators which move the first and the second sliders respectively in the first and the second directions, wherein in engaging portions of the first and the second sliders with the holding frame, gaps in a direction of the optical axis are larger than gaps in the first and the second directions.

### BACKGROUND OF THE INVENTION

1. Field of the Invention

The present invention relates to an image blur correcting device, and particularly relates to an image blur correcting device in portable equipment such as a slim camera.

2. Description of the Related Art

An image blur correcting device of a camera movably supports a correcting lens within a plane orthogonal to a photographing optical axis, and when a vibration is applied to the camera, the device moves the correcting lens in a direction to cancel out the vibration with an actuator, and thereby corrects the image blur. For example, in the image blur correcting device described in Japanese Patent No. 2641172, a fixing frame of a correcting lens is held by a first holding frame so as to be movable in a pitch direction, and the first holding frame is held at a second holding frame so as to be movable in a yaw direction. The correcting lens is moved in the pitch direction or in the yaw direction by using a pitch coil mounted to the fixing frame and a yaw coil mounted to the first holding frame, and an image blur is corrected.

In recent years, a digital camera which is reduced in thickness by using a bent optical system has been developed. In such a slim digital camera, there is a request for loading the above described image blur correcting device.

Incidentally, the image blur correcting device described in Japanese Patent No. 2641172 has the problem that a backlash occurs to a guide member which connects an actuator and the holding frame, and the holding frame cannot be moved accurately. Therefore, it is desired to assemble the guide member in the state without a backlash, but in such a case, there are the problems that sliding resistance in the guide member becomes large, and the holding frame cannot be quickly moved, and that an assembling operation becomes difficult.

### SUMMARY OF THE INVENTION

The present invention is made in view of the above circumstances, and has its object to provide an image blur correcting device which can move a correcting lens with high accuracy and is easy in an assembling operation.

In order to attain the above described object, the invention described in a first aspect is characterized by including a correcting optical system which corrects a blur of an image formed by an imaging optical system, a holding frame which holds the correcting optical system and is supported movably within a plane orthogonal to an optical axis of the imaging optical system, a first and a second sliders which are orthogonal to the optical axis, are supported respectively slidably in a first and a second directions which are different, and are engaged with the holding frame, and a first and a second actuators which move the first and the second sliders respectively in the first and the second directions, and in that in engaging portions of the first and the second sliders with the holding frame, gaps in a direction of the optical axis are larger than gaps in the first and the second directions.

According to the invention described in the first aspect, the gap between the slider and the holding frame is large in the direction of the optical axis, and therefore, the slider and the holding frame can be easily assembled. According to the invention described in the first aspect, the gaps between the sliders and the holding frame are small in the first and the second directions, namely, the transmission directions of the driving force. Therefore, the driving force can be accurately transmitted to the holding frame, and the holding frame can be moved with high accuracy.

In the invention described in the first aspect, the invention described in a second aspect is characterized in that the engaging portions are formed by guide shafts supported at the holding frame, and engaging holes which are formed in the first and the second sliders, and through which the guide shafts are inserted, and that the engaging holes have their sectional shapes longer in the direction of the optical axis than in the first and the second directions.

According to the invention described in the second aspect, the engaging holes are formed to be long in the direction of the optical axis, and therefore, the guide shafts can be easily inserted through the engaging holes. The engaging holes are formed to be short in the first and the second directions, namely, in the transmission directions of the driving force, and therefore, the driving force can be accurately transmitted to the holding frame.

According to the present invention, in the engaging portion of the holding frame which holds the correcting optical system, and the slider which transmits the driving force of the actuator to the holding frame, the gap between both of them is made large in the direction of the optical axis, and made small in the transmission direction of the driving force. Therefore, both of them can be easily assembled, and the holding frame can be moved with high accuracy.

### BRIEF DESCRIPTION OF THE DRAWINGS

FIG. 1 is a perspective view showing a digital camera to which an image blur correcting device according to the present invention is applied;

FIG. 2 a vertical sectional view of the digital camera in FIG. 1;

FIG. 3 is a perspective view showing the image blur correcting device according to the present invention;

FIG. 4 is an exploded perspective view of the image blur correcting device in FIG. 3;

FIG. 5 is a plane view of the image blur correcting device in FIG. 3;

FIG. 6 is a plane view of the image blur correcting device in which the holding frame in FIG. 5 is removed;

FIG. 7 is a perspective view showing an X-slider and a Y-slider;

FIG. 8 is a schematic view showing a shape of a guide of the holding frame;

FIG. 9 is a schematic view showing the shape of a guide of the X-slider; and

FIGS. 10A and 10B are perspective views showing boards which hold coils.

### DETAILED DESCRIPTION OF THE PREFERRED EMBODIMENTS

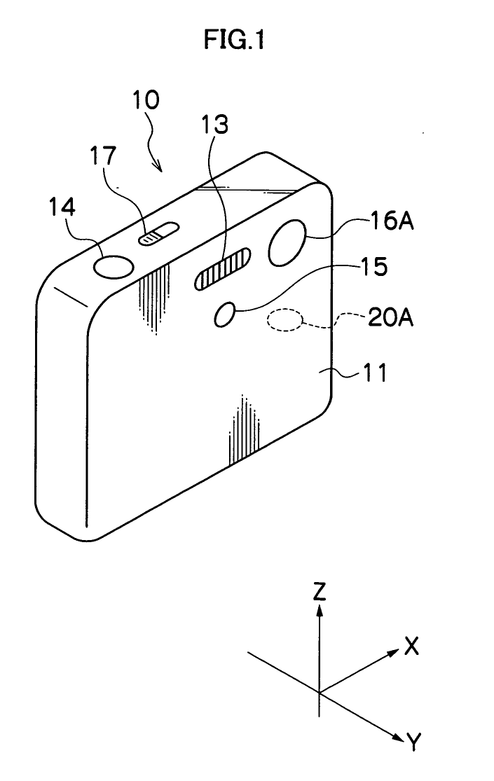

A preferred embodiment of an image blur correcting device according to the present invention will now be described in accordance with the accompanying drawings. FIG. 1 is a perspective view showing a digital camera 10 to which an image blur correcting device according to the present invention is applied. In the digital camera 10 shown in the drawing, a case 11 is formed into a thin rectangular shape, and a fixed lens 16A constructing a first lens group 16 of a photographing lens, a light emitting part 13 of an electronic flash and a light control sensor 15 for the electronic flash are placed on a front surface of the case 11. A shutter button 14 and a power supply switch 17 are placed on a top surface of the case 11. Hereinafter, a lateral direction seen from the front surface of the case 11 is set as an X-direction, a depth (thickness) direction is set as a Y-direction, and a height direction is set as a Z-direction.

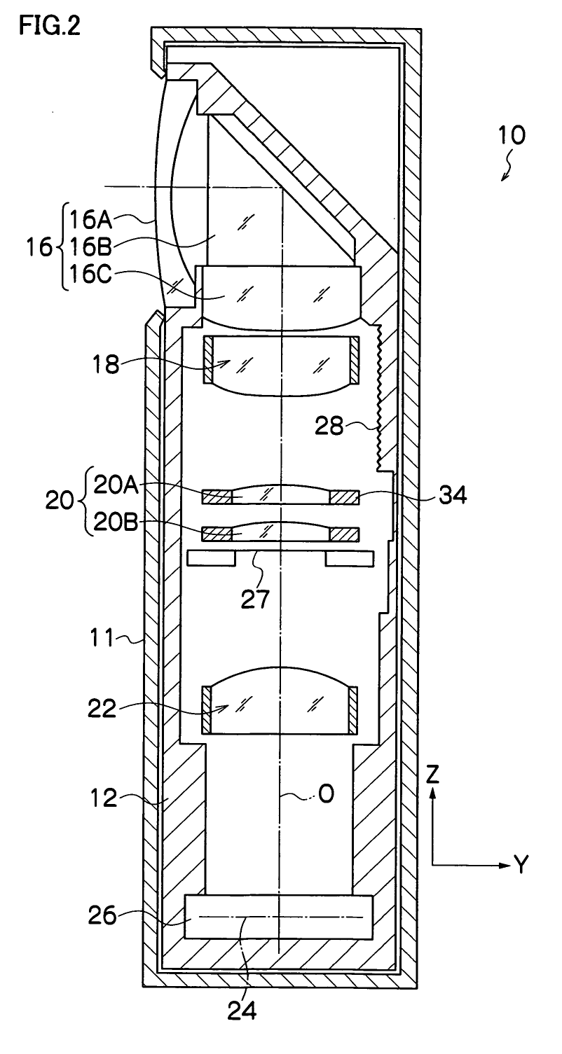

FIG. 2 is a vertical sectional view of the digital camera 10. As shown in the drawing, a camera body 12 is provided inside the case 11, and the first lens group 16, a second lens group 18, a third lens group 20 and a fourth lens group 22 are further provided inside the camera body 12. The first lens group 16, the second lens group 18 and the fourth lens group 22 construct an imaging optical system, and the third lens group 20 constructs a correcting optical system which corrects a blur of an image obtained by the imaging optical system.

The first lens group 16 is constructed by the fixed lens 16A disposed at the front surface of the case 11, a prism 16B disposed inside (back side) of the fixed lens 16A, and a fixed lens 16C disposed under the prism 16B, and bends an optical path of an observed image obtained via the fixed lens 16A downward at 90° by the prism 16B.

The second lens group 18, the third lens group 20 and the fourth lens group 22 are disposed below the first lens group 16, namely, along the optical axis in the Z-direction (hereinafter, simply called an optical axis O).

The second lens group 18 and the fourth lens group 22 are disposed slidably along the optical axis O, and slidingly move in the optical axis O direction by a drive device not shown. A zoom operation is performed by sliding the second lens group 18, and a focus operation is performed by sliding the fourth lens group 22.

A CCD 26 is placed at an imaging position 24 below the fourth lens group 22. Reference numeral 28 in FIG. 2 designates an anti-reflection surface on which small irregularities are repeatedly formed, and prevents light incident from the fixed lens 16A of the first lens group 16 from reflecting. Reference numeral 27 designates a shutter.

The third lens group 20 includes the movable correcting lens 20A and a fixed correcting lens 20B, and corrects an image blur by moving the movable correcting lens 20A within the plane orthogonal to the optical axis O (namely, within the XY-plane). A construction of an image blur correcting device 30 which moves the correcting lens 20A will be described.

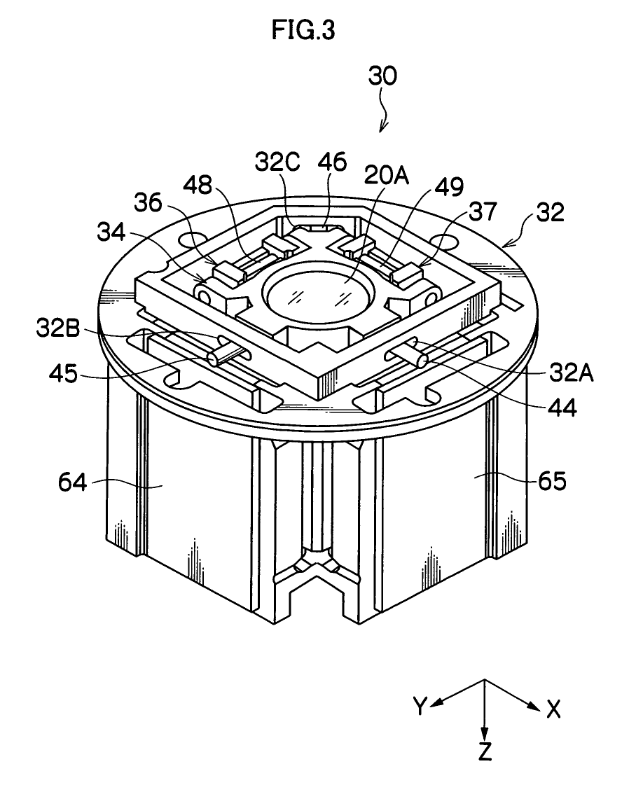

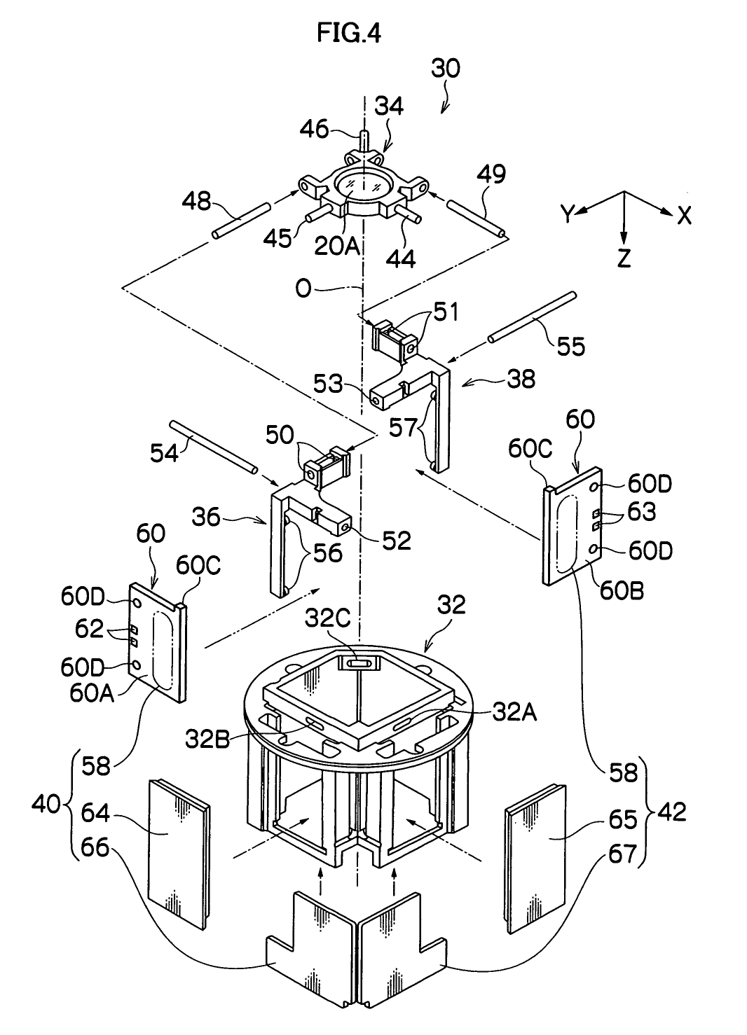

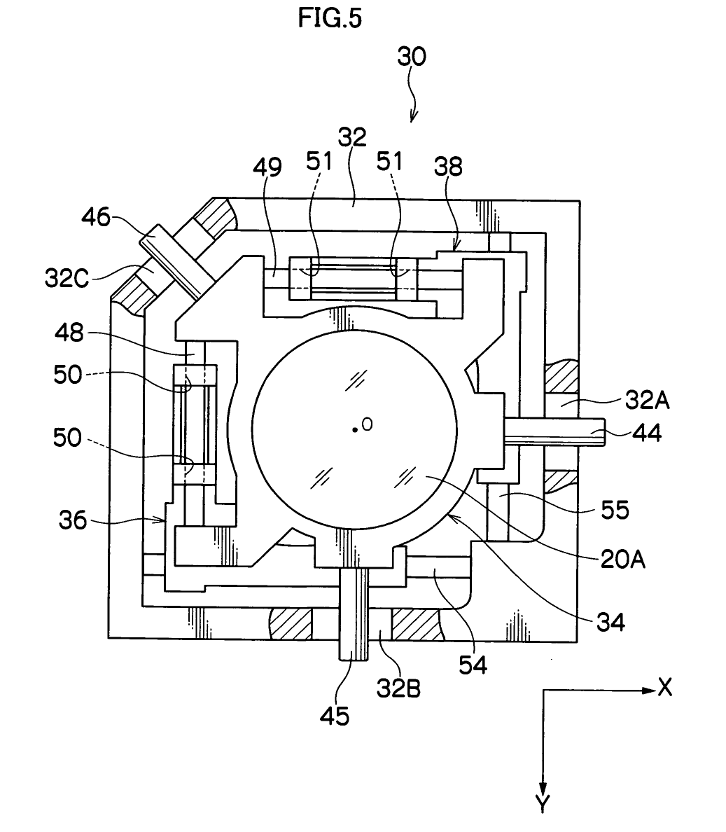

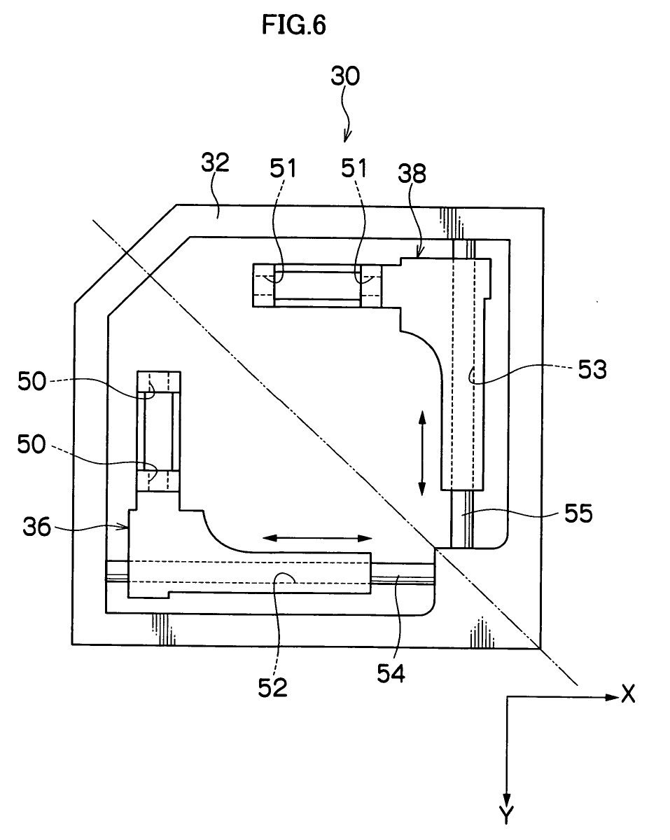

FIG. 3 is a perspective view showing an image blur correcting device 30, and FIG. 4 is an exploded perspective view thereof. FIG. 5 is a plane view of the image blur correcting device 30, and FIG. 6 is a plane view in which a holding frame 34 is removed from FIG. 5.

As shown in FIG. 4, the image blur correcting device 30 is mainly constructed by a substantially cylindrical body 32, the holding frame 34 which is movably supported at the body 32 and holds the correcting lens 20A, an X-slider 36 and a Y-slider 38 which are engaged with the holding frame 34, and an X-motor 40 and a Y-motor 42 (corresponding to actuators) for driving the X-slider 36 and the Y-slider 38 in the X-direction and the Y-direction respectively.

As shown in FIG. 4, three guide bars 44, 45 and 46 are mounted to the holding frame 34. The guide bar 44 is mounted at a substantially central position of the side surface in the Y-direction of the holding frame 34 along the X-direction as shown in FIG. 5. The guide bar 45 is mounted at a substantially central position of the side surface in the X-direction of the holding frame 34 along the Y-direction. The guide bar 46 is mounted at a corner portion of the holding frame 34, which is the farthest away from the guide bars 44 and 45, along the direction of the diagonal line.

The respective guide bars 44 to 46 are inserted into grooves 32A to 32C of the body 32. As shown in FIG. 8, the groove 32A is formed so that a dimension L3 in the direction of an optical axis O) (Z-direction) is substantially the same dimension as a diameter D2 of the guide bar 44, and a dimension L4 in the direction (Y-direction) orthogonal to the optical axis O is larger than the diameter D2 of the guide bar 44. Accordingly, the guide bar 44 is engaged with the groove 32A without a gap in the direction of the optical axis O, and is supported at the groove 32A movably in the direction orthogonal to the optical axis O.

Similarly, the groove 32B in FIG. 5 is formed so that the dimension in the direction of the optical axis O is substantially the same dimension as the diameter of the guide bar 45, and the dimension in the direction orthogonal to the optical axis O is larger than the diameter of the guide bar 45. The groove 32C is formed so that the dimension in the direction of the optical axis O is substantially the same dimension as the diameter of the guide bar 46, and the dimension in the direction orthogonal to the optical axis O is larger than the diameter of the guide bar 46. Accordingly, the guide bars 45 and 46 are engaged with the grooves 32B and 32C without a gap in the direction of the optical axis O, and are supported at the grooves 32B and 32C movable in the direction orthogonal to the optical axis O. Thereby, the holding frame 34 is supported without a backlash in the direction of the optical axis O and movably in the direction orthogonal to the optical axis O.

At the holding frame 34, a movable guide shaft 48 is mounted to a side surface at a side opposite from the side surface, to which the guide bar 44 is mounted, along the Y-direction. Further at the holding frame 34, a movable guide shaft 49 is mounted to a side surface at a side opposite from the side surface, to which the guide bar 45 is mounted, along the X-direction. The X-slider 36 and the Y-slider 38 are slidably engaged with these movable guide shafts 48 and 49.

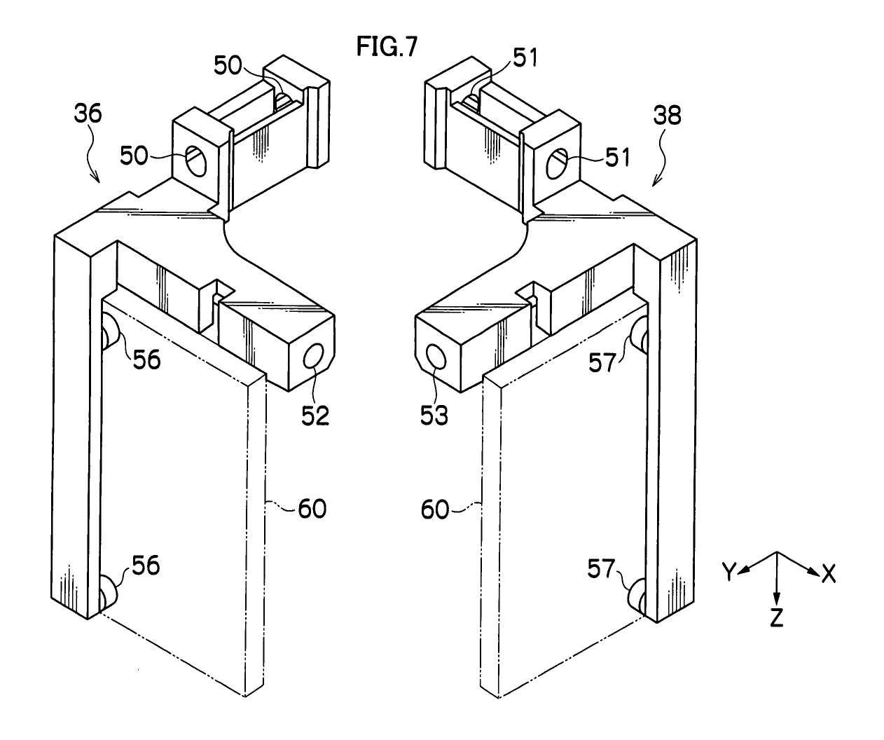

As shown in FIGS. 6 and 7, the X-slider 36 and the Y-slider 38 are formed in the shapes symmetric with respect to a plane. Namely, as shown in FIG. 6, the X-slider 36 is formed in a substantially L shape in the plane view, and the Y-slider 38 is formed into the inversed L shape to be in the shape symmetric about a plane with the X-slider 36 with respect to the symmetry plane shown by the two-dot chain line.

In the X-slider 36, guide holes (corresponding to the engaging holes) 50 and 50 through which the above described movable guide shaft 48 (see FIG. 5) is inserted are formed. The X-slider 36 is engaged with the holding frame 34 slidably in the Y-direction by the movable guide shaft 48 being inserted through the guide holes 50 and 50.

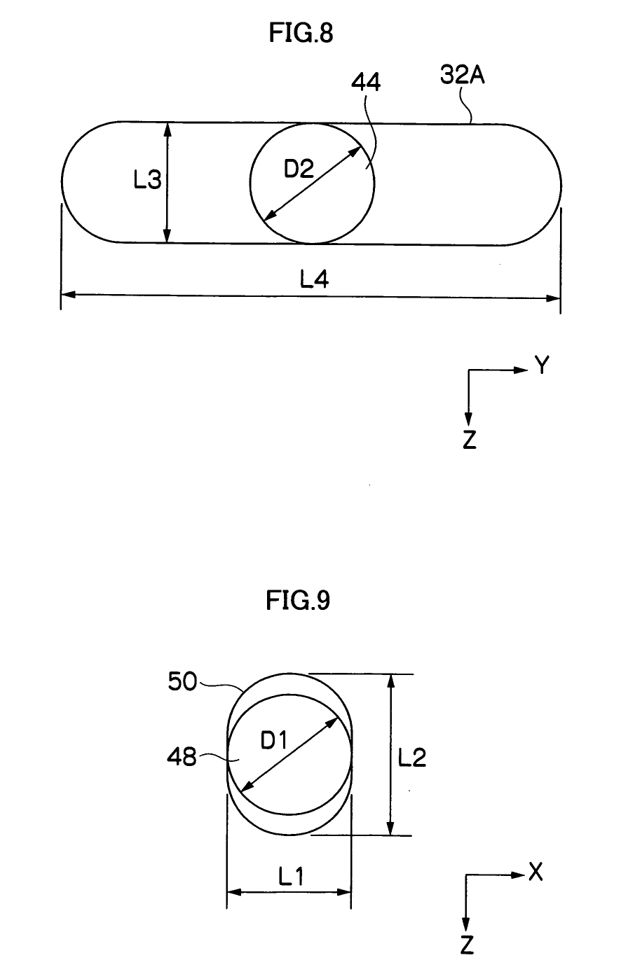

As shown in FIGS. 7 and 9, each of the guide holes 50 is formed into a long circular shape which is longer in the Z direction than in the X-direction. More specifically, the dimension L1 in the X-direction of the guide hole 50 is made substantially the same dimension as an outside diameter dimension D1 of the movable guide shaft 48, and the dimension L2 in the Z-direction of the guide hole 50 is made larger than the outside diameter dimension D1 of the movable guide shaft 48. Accordingly, when the movable guide shaft 48 is inserted through the guide hole 50, the movable guide shaft 48 and the guide hole 50 are engaged with each other without a gap in the X-direction. As a result, when the X-slider 36 is moved in the X-direction, the holding frame 34 can be accurately moved in the X-direction via the movable guide shaft 48. Meanwhile, since a gap exists in the Z-direction, the movable guide shaft 48 can be easily inserted through the guide hole 50, and favorable assembly property is provided.

As shown in FIG. 7, a through-hole 52 is formed in the X-direction in the X-slider 36. A fixed guide shaft 54 shown in FIG. 6 is inserted through the through-hole 52. The fixed guide shaft 54 is disposed along the X-direction, and its both end portions are fixed to the body 32. Thereby, the X-slider 36 is supported at the body 32 slidably in the X-direction. The sectional shape of the though-hole 52 is not especially limited, and it may be a circular shape, or it may be formed into a long circular shape longer in the Z-direction as the guide hole 50.

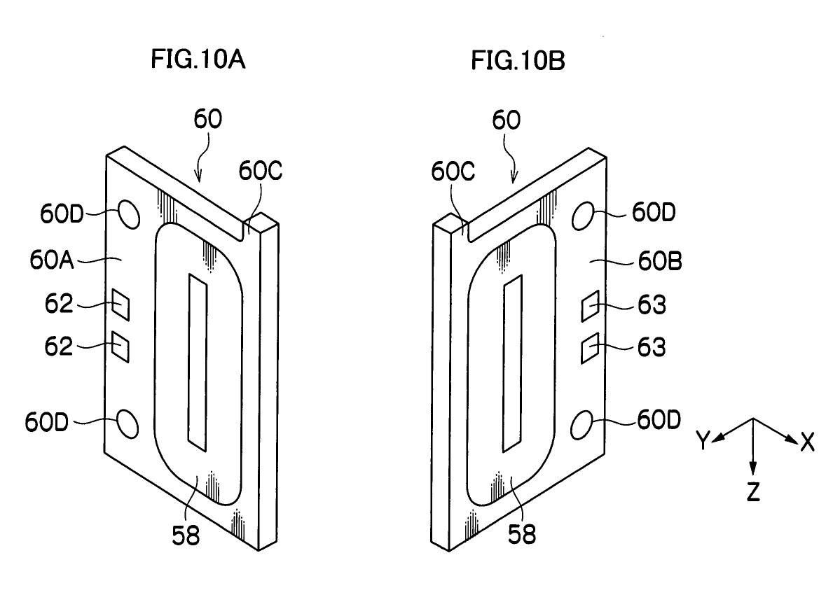

As shown in FIG. 4, a board 60 is mounted to the X-slider 36 so as to be parallel with the optical axis O. A coil 58 which constructs the X-motor 40 is printed on the board 60. As shown in FIGS. 10A and 10B, the coil 58 is formed into a long circular shape longer in the Z-direction. The coil 58 is printed to be superimposed on one another in a plurality of layers, and its terminals are provided on both surfaces of the board 60. Namely, as shown in FIG. 10A, terminals 62 and 62 are provided on a front surface 60A of the board 60, and as shown in FIG. 10B, terminals 63 and 63 are provided on a back surface 60B of the board 60. Accordingly, when one of the terminals 62 and 62 and the terminals 63 and 63 are connected to a lead wire, an electric current can be passed to the coil 58. The lead wire is connected to the inner terminals 63 and 63 in the substrate 60 which is fitted to the X-slider 36.

An engaging projection 60C, and engaging holes 60D and 60D are formed in the board 60. By engaging the engaging projection 60C, and the engaging holes 60D and 60D respectively in the engaging grooves (not shown) and engaging pins 56 and 56 of the X-slider 36 in FIG. 4, the board 60 is mounted to the X-slider 36.

The X-motor 40 is constructed by the above described coil 58, a planar magnet 64 and a yoke 66 mounted to the body 32. The magnet 64 and the yoke 66 are disposed to be opposed to each other with the coil 58 therebetween, and are fixed to the body 32. In the magnet 64, an N-pole and an S-pole are disposed so that magnetic lines of force are formed in the Y-direction at the position of the coil 58, and the yoke 66 is constructed so that the magnetic lines of force become intense. In the X-motor 40 constructed like this, the coil 58 is energized, and thereby the X-slider 36 which holds the coil 58 is moved in the X-direction. Accordingly, the holding frame 34 which is engaged with the X-slider 36 via the movable guide shaft 48 can be driven in the X-direction.

Meanwhile, in the Y-slider 38, guide holes (corresponding to engaging holes) 51 and 51 through which the above described movable guide shaft 49 is inserted are formed. The Y-slider 38 is engaged with the holding frame 34 slidably in the X-direction by the movable guide shaft 49 being inserted through the guide holes 51 and 51.

Each of the guide holes 51 is formed into a long circular shape longer in the Z-direction as the guide hole 50 shown in FIG. 8. More specifically, the dimension in the Y-direction of the guide hole 51 is made substantially the same dimension as an outside diameter of the movable guide shaft 49, and the dimension in the Z-direction of the guide hole 51 is made larger than the outside diameter of the movable guide shaft 49. Accordingly, when the movable guide shaft 49 is inserted through the guide hole 51, the movable guide shaft 49 is engaged with the guide hole 51 without a gap in the Y-direction. As a result, when the Y-slider 38 is moved in the Y-direction, the holding frame 34 can be accurately moved in the Y-direction via the movable guide shaft 49. Meanwhile, since a gap exists in the Z-direction, the movable guide shaft 49 can be easily inserted through the guide hole 51, and favorable assembly property is provided.

A through-hole 53 is formed in the Y-direction in the Y-slider 38, and a fixed guide shaft 55 is inserted through the through-hole 53. The fixed guide shaft 55 is disposed along the Y-direction, and its both end portions are fixed to the body 32. Thereby, the Y-slider 38 is supported at the body 32 slidably in the Y-direction. The sectional shape of the though-hole 53 is not especially limited, and it may be a circular shape, or it may be formed into a long circular shape longer in the Z-direction as the guide hole 51.

The board 60 is mounted to the Y-slider 38 to be parallel with the optical axis O. The board 60 is the same as the board 60 mounted to the above described X-slider 36, and the engaging projection 60C, and the engaging holes 60D and 60D are formed in the board 60. The board 60 is mounted to the Y-slider 38 by engaging the engaging projection 60C and the engaging holes 60D and 60D with an engaging groove (not shown) of the Y-slider 38, and engaging pins 57 and 57. On this occasion, the boards 60 are mounted in the different postures to the X-slider 36 and the Y-slider 38. Namely, to the X-slider 36, the board 60 is mounted in the posture with the front surface 60A of the board 60 facing outside (see FIG. 10A), and to the Y-slider 38, the board 60 is mounted in the posture with the back surface 60B of the board 60 facing outside (see FIG. 10B). In the board 60 which is mounted to the Y-slider 38, the lead wire is connected to the inside terminals 62 and 62, and an electric current is supplied via the lead wire.

The Y-motor 42 is constructed by the above described coil 58, a planar magnet 65 and a yoke 67 which are mounted to the body 32. The magnet 65 and the yoke 67 are disposed to be opposed to each other with the coil 58 therebetween, and are fixed to the body 32. In the magnet 65, an N-pole and an S pole are disposed so that magnetic lines of force are formed in the X-direction at the position of the coil 58, and the yoke 67 is constructed so that the magnetic lines of force become intense. In the Y-motor 42 constructed like this, the Y-slider 38 which holds the coil 58 is moved in the Y-direction by energizing the coil 58. Accordingly, the holding frame 34 which is engaged with the Y-slider 38 via the movable guide shaft 49 can be driven in the Y-direction.

The above described X-slider 36, Y-slider 38, X-motor 40 and Y-motor 42 are collectively placed at the photographic subject side of the holding frame 34, and are incorporated into the substantially cylindrical body 32 and unitized as shown in FIG. 3. Accordingly, the image blur correcting device 30 can be made compact, and can be easily incorporated into the camera 10.

A position detecting sensor (not shown) which detects the positions of the X-slider 36 and the Y-slider 38 may be provided at the image blur correcting device 30. The kind of the position detecting sensor is not especially limited, but the position detecting sensor is properly constructed by Hall elements mounted to, for example, the X-slider 36 and the Y-slider 38 and magnets which are disposed to be opposed to the Hall elements and fixed to the body 32. Thereby, the positions of the X-slider 36 and the Y-slider 38, namely, the position of the holding frame 34 can be controlled.

It is suitable to provide a vibration detecting sensor (not shown) at the camera body 12 of the camera 10, and perform drive control of the X-motor 40 and the Y-motor 42 in accordance with the detection value of the sensor.

Next, an operation of the image blur correcting device 30 constructed as described above will be described.

When the vibration of the camera 10 is detected with a sensor (not shown), the X-motor 40 or the Y-motor 42, or both the motors 40 and 42 is or are driven in accordance with the direction of the detected vibration. When the X-motor 40 is driven, the coil 58 is energized, and the X-slider 36 which holds the coil 58 moves in the X-direction. Accordingly, the holding frame 34 engaged with the X-slider 36 via the movable guide shaft 48 moves in the X-direction, and the correcting lens 20A moves in the X-direction. On this occasion, the Y-slider 38 engages with the holding frame 34 slidably in the X-direction, and therefore, it does not move. Accordingly, when the X-motor 40 is driven, only the X-slider 36 can be independently moved without moving the Y-slider 38 and the Y-motor 42, and the holding frame 34 can be quickly moved.

When the X-motor 40 is driven, the holding frame 34 can be moved in the X-direction with high accuracy since the movable guide shaft 48 and the guide hole 50 of the X-slider 36 are engaged with each other without a gap in the X-direction. Like this, according to the embodiment, the holding frame 34 can be quickly moved with high accuracy in the X-direction when the X-motor 40 is driven.

Similarly, when the Y-motor 42 is driven, the Y-slider 38 which holds the coil 58 moves in the Y-direction. Accordingly, the holding frame 34 which engages with the Y-slider 38 via the movable guide shaft 49 moves in the Y-direction, and the correcting lens 20A moves in the Y-direction. On this occasion, the X-slider 36 is engaged with the holding frame 34 slidably in the Y-direction, and does not move. Accordingly, when the Y-motor 42 is driven, only the Y-slider 38 can be independently moved without moving the X-slider 36 and the X-motor 40, and the holding frame 34 can be quickly moved.

When the Y-motor 42 is driven, the holding frame 34 can be moved in the Y-direction with high accuracy since the movable guide shaft 49 and the guide hole 51 of the Y-slider 38 are engaged with each other without a gap in the Y-direction. Like this, according to the embodiment, when the Y-motor 42 is driven, the holding frame 34 can be quickly moved in the Y-direction with high accuracy.

As described above, according to the image blur correcting device 30 of this embodiment, the movable guide shaft 48 supported at the holding frame 34 and the guide hole 50 of the X-slider 36 are engaged with each other without a gap in the X-direction, and the movable guide shaft 49 supported at the holding frame 34 and the guide hole 51 of the Y-slider 38 are engaged with each other without a gap in the Y-direction. Therefore, the holding frame 34 can be moved in the X-direction and the Y-direction with high accuracy.

According to this embodiment, since the guide holes 50 and 51 are formed to be larger in the direction of the optical axis O than the movable guide shafts 48 and 49, the movable guide shafts 48 and 49 can be easily inserted through the guide holes 50 and 51, and very good assembly property is provided.

In the above described embodiment, the guide holes 50 and 51 are each formed into a long circular shape longer in the direction of the optical axis O, but the shapes of the guide holes 50 and 51 are not limited to this, and it is suitable that the gaps with respect to the movable guide shafts 48 and 49 are small in the X-and Y-directions, and are large in the direction of the optical axis O. Accordingly, for example, the sectional shapes of the movable guide shafts 48 and 49 may be formed to be long in the X-and Y-directions, and short in the direction of the optical axis O.

What is claimed is:

1. An image blur correcting device, comprising:
a correcting optical system which corrects a blur of an image formed by an imaging optical system;
a holding frame which holds the correcting optical system and is supported movably within a plane orthogonal to an optical axis of the imaging optical system;
a first and a second sliders which are orthogonal to the optical axis, are supported respectively slidably in a first and a second directions which are different, and are engaged with the holding frame; and
a first and a second actuators which move the first and the second sliders respectively in the first and the second directions,
wherein in engaging portions of the first and the second sliders with the holding frame, gaps in a direction of the optical axis are larger than gaps in the first and the second directions.

2. The image blur correcting device according to claim 1, wherein
the engaging portions include guide shafts supported at the holding frame, and engaging holes which are formed in the first and the second sliders, through which the guide shafts are inserted, and which have their sectional shapes longer in the direction of the optical axis than in the first and the second directions.
